(19) United States
(12) Patent Application Publication
(10) Pub. No.: US 2019/0206109 A1
(43) Pub. Date: Jul. 4, 2019

(54) METHOD, APPARATUS AND DEVICE FOR GENERATING LIVE WALLPAPER AND MEDIUM

(71) Applicant: ZHUHAI JUNTIAN ELECTRONIC TECHNOLOGY CO., LTD., Zhuhai (CN)

(72) Inventor: Ming Yan Jonathan Chu, Beijing (CN)

(73) Assignee: ZHUHAI JUNTIAN ELECTRONIC TECHNOLOGY CO., LTD., Zhuhai (CN)

(21) Appl. No.: 16/224,909

(22) Filed: Dec. 19, 2018

(30) Foreign Application Priority Data
Dec. 29, 2017 (CN) 201711499653.9

(51) Int. Cl. G06T 13/40; G06T 15/04; G06T 19/20

(52) U.S. Cl. CPC G06T 13/40; G06T 2219/2012; G06T 19/20; G06T 15/04

(57) ABSTRACT

Embodiments of the present disclosure provide a method, an apparatus and a device for generating a live wallpaper and a medium. The method includes: acquiring vertex data extracted from a three-dimension model or point cloud data; adding a vertex color to the vertex data; and generating the live wallpaper according to the vertex data with the added vertex color. With embodiments of the present disclosure, the live wallpaper is generated in a point-rendering manner, such that a crumpling situation due to the points cannot forming a triangle may be avoided.

### CROSS-REFERENCE TO RELATED APPLICATION

The present application is based upon and claims priority to Chinese Patent Application No. 201711499653.9, filed on Dec. 29, 2017, the entirety contents of which are incorporated herein by reference.

### TECHNICAL FIELD

The present disclosure relates to a field of electronic technology, and more particularly, to a method, an apparatus and a device for generating a live wallpaper and a medium.

### BACKGROUND

In prior art, a live wallpaper of a smart phone is generally generated by configuring a mapping with a 3D model and then performing a rendering with triangle faces according to vertexes of the model.

Such 3D rendering in prior art is suitable for acquiring the live wallpaper in a general situation. However, it is difficult to meet some special visual needs (such as a high-tech holographic projection effect, a water splash scene, etc.), for example, for a scene where there is a drastically distorted vertex animation, a crumpling situation may appear because the points cannot form a triangle. Therefore, a technical problem to be solved currently is how to design to generate the live wallpaper so as to meet certain special visual needs (such as the high-tech holographic projection effect, the water splash scene, etc.).

### SUMMARY

Embodiments of the present disclosure provide a method, an apparatus and a device for generating a live wallpaper, and a medium, so as to perform a rendering with points to generate the live wallpaper, such that a crumpling situation due to the points cannot forming a triangle may be avoided.

A first aspect of embodiments of the present disclosure provides a method for generating a live wallpaper. The method may include: acquiring vertex data extracted from a three-dimension model or point cloud data; adding a vertex color to the vertex data; and generating the live wallpaper according to the vertex data with the added vertex color.

A second aspect of embodiments of the present disclosure provides an apparatus for generating a live wallpaper. The apparatus may include: an acquiring unit, configured to acquire vertex data extracted from a three-dimension model or point cloud data; an adding unit, configured to add a vertex color to the vertex data; and a generating unit, configured to generate the live wallpaper according to the vertex data with the added vertex color.

A third aspect of embodiments of the present disclosure provides a device for generating a live wallpaper. The device may include: a processor, a memory, a communication interface and a bus, in which the processor, the memory and the communication interface are connected via the bus and communicate with each other; the memory is configured to store executable program codes; and the processor is configured to perform a program corresponding to the executable program codes by reading the executable program codes stored in the memory, so as to perform the method for generating a live wallpaper according to the first aspect or any possible implementation of the first aspect.

A fourth aspect of embodiments of the present disclosure provides a storage medium, having computer programs stored therein, in which the computer programs includes program instructions, when the program instructions are executed by a processor, the method for generating a live wallpaper according to embodiments of the present disclosure.

A fifth aspect of embodiments of the present disclosure provides an application program, when the application program is executed, the application program is configured to perform the method for generating a live wallpaper according to embodiments of the present disclosure.

### BRIEF DESCRIPTION OF THE DRAWINGS

In order to further clearer describe technical solutions of embodiments of the present disclosure, simply descriptions will be made to drawings necessitated by describing embodiments of the present disclosure.

FIG. 1 is a schematic diagram illustrating a model of a dolphin provided by an embodiment of the present disclosure;

FIG. 2 is a schematic diagram illustrating coordinates of vertexes in a 3D model provided by an embodiment of the present disclosure;

FIG. 3 is a schematic diagram illustrating a 3D model provided by an embodiment of the present disclosure;

FIG. 4 is a schematic diagram illustrating a mapping provided by an embodiment of the present disclosure;

FIG. 5 is a schematic diagram illustrating a sphere model provided by an embodiment of the present disclosure;

FIG. 6A is a schematic diagram illustrating determining a lighting effect according to a normal vector provided by an embodiment of the present disclosure;

FIG. 6B is a schematic diagram illustrating a rendering manner provided by an embodiment of the present disclosure;

FIG. 7 is a flow chart illustrating a method for generating a live wallpaper provided by an embodiment of the present disclosure;

FIG. 8 is a structure diagram illustrating an apparatus for generating a live wallpaper provided by an embodiment of the present disclosure; and

FIG. 9 is a structure diagram illustrating a device for generating a live wallpaper provided by an embodiment of the present disclosure.

### DETAILED DESCRIPTION

In order to facilitate a better understanding of the preset disclosure, some concepts involved in the present disclosure are introduced firstly.

1. Point Cloud

The point cloud is a set of massive points of a target surface acquired by a measuring instrument. The point cloud acquired according to a laser measurement principle (e.g., measured by a laser scanner) includes three-dimension coordinates (XYZ) and a laser reflecting intensity (Intensity).

The point cloud acquired according to a photogrammetric principle (e.g., measured by a camera) includes the three-dimension coordinates (XYZ) and color information (RGB).

The point cloud acquired according to a combination of the laser measurement principle and the photogrammetric principle includes the three-dimension coordinates (XYZ), the laser reflecting intensity (Intensity) and the color information (RGB).

After space coordinates of each sample point on the object surface are acquired, a set of points is acquired, which is the so-called point cloud.

A format of the point cloud includes but not be limited to: pts, asc, dat, stl, imw and xyz.

Point cloud data refer to data of the above-mentioned point cloud, including the three-dimension coordinates, the color information and the laser reflecting intensity. The three-dimension coordinates refer to a geometric position of the point cloud. The color information generally refers to the color information of a pixel at a corresponding position in a color image acquired by the camera which is assigned to a corresponding point in the point cloud. The intensity information refers to the echo intensity collected by a laser scanner receiving device. This intensity information is related to a surface material, a roughness, a direction of an incident angle, an emission energy and a laser wavelength of the instrument.

2. 3D Model

The 3D model is a three-dimension, stereoscopic model, and D is short for Dimensions.

The 3D model may also be called a three-dimension model built with 3D software, including a variety of constructions, people, vegetation, machinery and the like, such as a 3D model of a building. The 3D model also includes fields of toys and computer models.

For example, referring to FIG. 2, which is a schematic diagram illustrating coordinates of vertexes in a 3D model provided by an embodiment of the present disclosure. The left figure (a) in FIG. 2 illustrates two adjacent triangles, three vertexes of a first triangle are labeled by V0, V1 and V2, of which the coordinates are (0, 0), (2, 0) and (1, 2) respectively, and three vertexes of a second triangle are labeled by V3, V4 and V5, of which the coordinates are (1, 2), (2, 0) and (3, 2) respectively. Three vertexes constituting a same triangle are connected/adjacent to each other, and the two adjacent triangles are intersected at a same point. The right figure (b) in FIG. 2 illustrates two adjacent triangles, three vertexes of a first triangle are labeled by V0, V1 and V2, of which the coordinates are (0, 0), (2, 0) and (1, 2) respectively, and three vertexes of a second triangle are labeled by V1, V2 and V3, of which the coordinates are (1, 2), (2, 0) and (3, 2) respectively. Three vertexes constituting a same triangle are connected/adjacent to each other. It is shown in the right figure (b) in FIG. 2 that which vertexes constitute a same triangle, i.e., vertexes V0, V1 and V2 constitute a same triangle, and vertexes V1, V2 and V3 constitute a same triangle. It should be noted that, two-dimensional coordinates are taken as an example in FIG. 2 to briefly introduce the coordinates of the vertexes in the 3D model. In practical applications, the coordinates of the vertexes in the 3D model are three-dimension coordinates.

A format of the 3D model includes but not be limited to: obj, fbx, dae and the like.

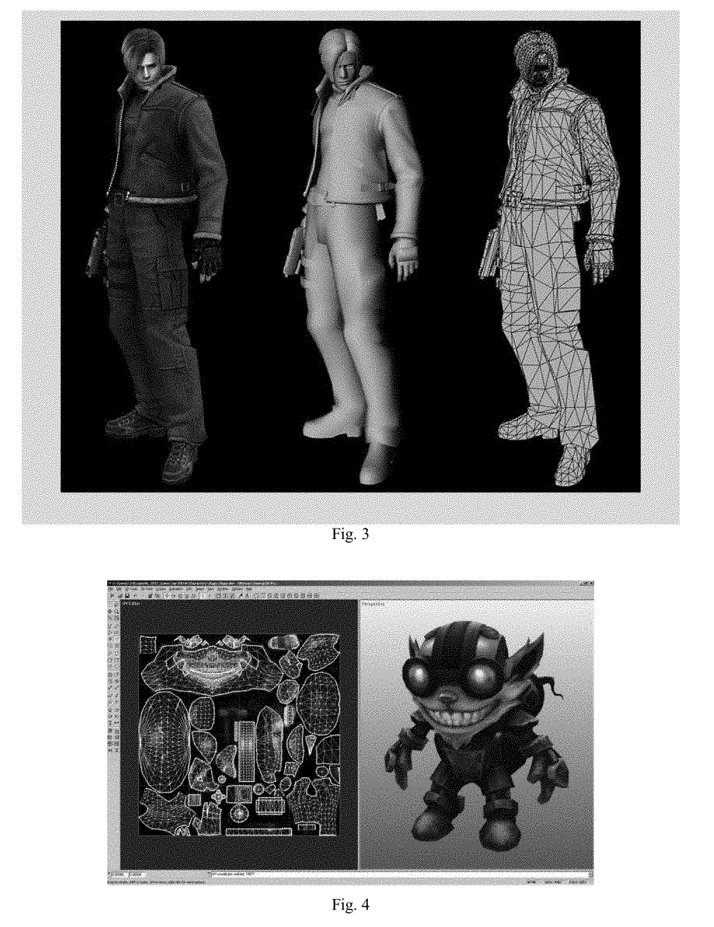

Every three vertexes constitute a triangle, and a number of triangles may form a 3D model. For example, the figure furthest to the right in FIG. 3 is a schematic diagram of a 3D model.

Each vertex has its own vertex data. Generally, the vertex data include: a position (i.e., coordinates), UV and a normal vector. The vertex data includes the above-mentioned information but not be limited thereto.

When rendering a 3D model, a mapping an UV are required. As shown in FIG. 4, the mapping and the UV are illustrated at left, and an actually rendered model effect is illustrated at right. The 3D model is acquired by attaching the corresponding mapping on the corresponding triangle face according to the UV. The UV of each vertex of each triangle in the 3D model corresponds to the UV of the mapping. A color of a pixel corresponding to the UV of the mapping may represent a color of the vertex.

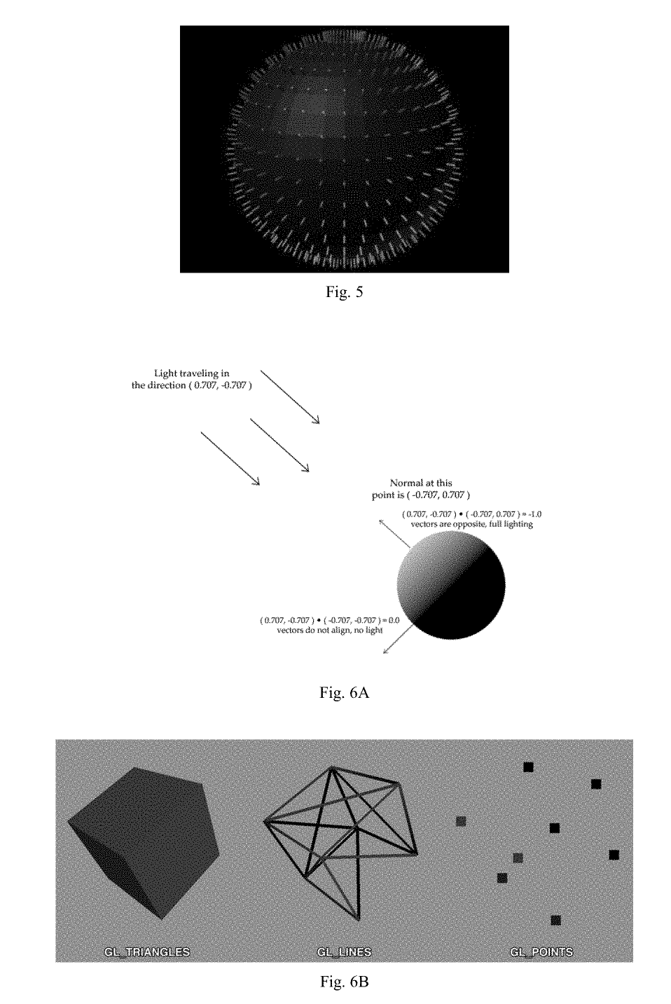

FIG. 5 illustrates a sphere model, in which white lines are normal vectors. The normal vectors inform a graphics card a direction of each vertex, such that a light effect may be computed by using the vertexes. Taking FIG. 6A as an example, there is a direction light at a top left corner, which directs to a sphere at a bottom right corner. A dot product of a vertex normal vector and a direction light vector is computed for the sphere illustrated at the bottom right corner. A light degree (which is a value ranging from 0 to 1) of the vertex is computed according to the dot product, and then performing the rendering, such that the effect of FIG. 6A is achieved.

The rendering process of the 3D model will be described in following.

Imagine an image as a Go chessboard, each grid on the chessboard has its own color, and the color may be expressed as three digits, such that the image is finally expressed as a series of numerical values. When drawing the image, a game will inform the screen the numerical values of the image, and the screen may draw the image according to these numerical values.

Firstly, what is a 3D model will be described by taking a watermelon in a game Fruit Ninja as an example.

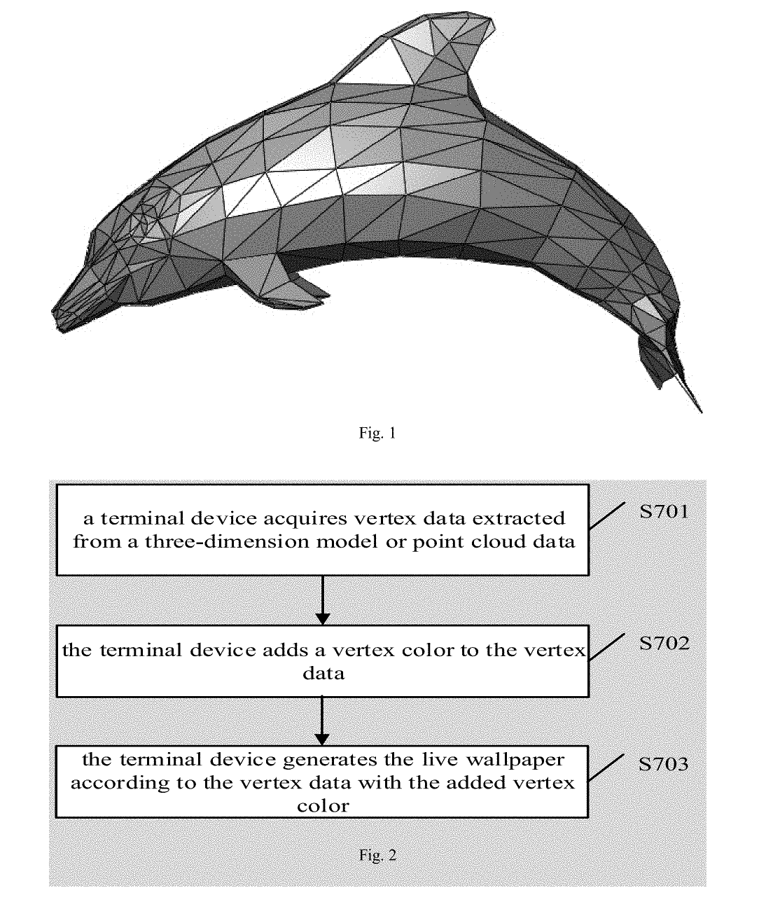

Assume that we buy a real watermelon at a fruit stand and then poke holes on the watermelon rind with a needle. The poking may be regarded as picking a point on the surface of the watermelon. After poking for an hour, hundreds of points may be acquired, and then adjacent points are connected with straight lines to form small triangles. When all points are connected, a 3D model is got. These poked points are called the vertexes of the 3D model, the straight lines between the vertexes are called edges of the 3D model, and the triangles are called faces of the 3D model. These points, edges, and faces constitute a very complex polyhedron, which is the geometric model of the watermelon. The dolphin model shown in FIG. 1 provides an intuitive example.

The position of each point and the color of each face are recorded. It is easy to understand the position of the point. The color of the face is explained as follows. For the sake of simplicity, a rule is made: if three points of a face are poked on a part of black melon pattern, the color of the face is set as black, otherwise, the color of the face is set as green. After recording, the numerical expression of the watermelon model is acquired, in which not only the geometrical positions, but also the colors are recorded.

After that, how to draw the 3D model on the screen will be descried as follows. The drawing process may still be regarded as a process of assigning a color value to each pixel, although the value assigning process is rather complicated at present.

The 3D model of the watermelon is placed somewhere at back of the screen, and then a point which is called focus point is selected in front of the screen. It is well-known that two points determine a straight line. Therefore, each pixel on the screen may be connected to the focus point to determine a straight line. If the straight line intersects a certain face on the watermelon model, the color of the face (green or black) is assigned to the pixel. If the straight line does not intersect the watermelon model, a background color (such as gray) is assigned to the pixel. In this way, after all pixels are assigned with a color, the watermelon may be drawn on a gray background.

In the game Fruit Ninja, when a watermelon pops out, the watermelon jumps out and rolls over. In each frame, the position of each vertex of the model may be computed in the game according to a physical rule. After that, the model may be rendered according to the above-described method. In prior art, a live wallpaper on a mobile phone is generally rendered based on the triangle faces successively. For example, in FIG. 6B, the triangle faces are drawn one by one in a GL_TRIANGLES face-rendering manner in prior art.

In embodiments of the present disclosure, discrete vertex data may be extracted from the point cloud data of the 3D model/3D scanning, the live wallpaper may be rendered based on independent points rather than triangle faces, such that a crumpling situation due to the points cannot fondling the triangle may be avoided. For example, as shown in FIG. 6B, the vertexes are rendered in a GL_POINT point-rendering manner. GL LINES shown in FIG. 6B is a line-rendering manner.

Technical solutions in embodiments of the present disclosure are described in following.

Terminal devices described in embodiments of the present disclosure include a smart phone (e.g., a phone with Android system, a phone with iOS system, Windows Phone etc.), a tablet, a simulator and the like.

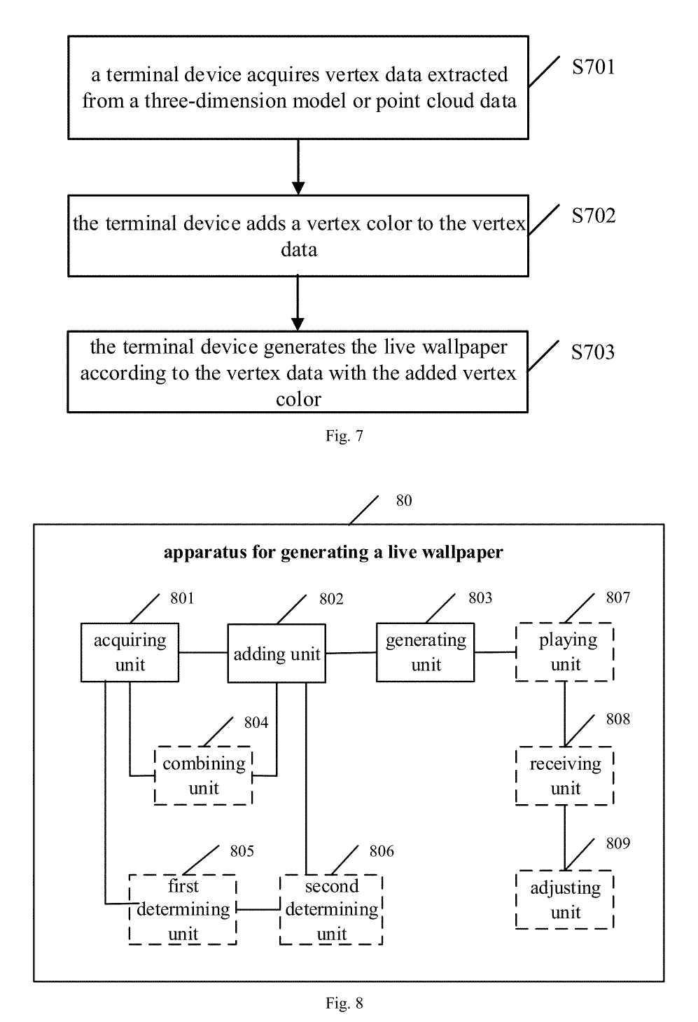

Referring to FIG. 7, FIG. 7 is a flow chart illustrating a method for generating a live wallpaper provided by an embodiment of the present disclosure. As shown in FIG. 7, the method for generating a live wallpaper may include but not be limited to followings.

At block S701, a terminal device acquires vertex data extracted from a three-dimension model or point cloud data.

In embodiments of the present disclosure, the vertex data include three-dimension coordinates corresponding to the vertex data. A format of the 3D model includes but not be limited to: obj, fbx, dae and the like. Each format corresponds respectively to a vertex reading method. Taking an obj model as an example, data of the 3D model may be described in following.

# obj adding a symbol # in front of an annotation

# a vertex position begins with the letter v, in which x coordinate, y coordinate and z coordinate follow the letter v

v 0.123 0.234 0.345 #0.123 is the x coordinate, 0.234 is the y coordinate, 0.345 is the z coordinate

v 0.987 0.654 0.321 #0.987 is the x coordinate, 0.654 is the y coordinate, 0.321 is the z coordinate

. . .

# a vertex UV begins with the letters vt, in which u coordinate and v coordinate follow the letters vt

vt 0.500 1 #0.500 is the u coordinate, 1 is the v coordinate

vt . . .

. . .

# a vertex normal vector begins with the letters vn, in which x value, y value and z value of the vector follow the letters vn

vn 0.707 0.000 0.707 #0.707 is the x value, 0.000 is the y value, 0.707 is the z value

vn . . .

. . .

# an index of vertexes of each face begins with a letter f, the index increases progressively starting from 1, e.g., the index of the above-mentioned v 0.123 0.234 0.345 is 1, and the index of the above-mentioned v 0.987 0.654 0.321 is 2

# a slash / is added, indexes of the UV and the normal vector are specified after the slash /

f 1 2 3

f 3/1 4/2 5/3

f 6/4/1 3/5/3 7/6/5

f 7//1 8//2 9//3

f . . .

. . .

Therefore, all vertex data may be read by a program according to vertex listing method for each format.

The point cloud data is basically same as the 3D model, except that there is no concept of faces in the point cloud data, but only vertexes. Therefore, all vertex data in the point cloud data may also be read by a program.

After all vertex data of the 3D model/point cloud data are acquired, these vertex data may be added to a vertex array list.

After that, distances between connected vertexes in the vertex array list are compared: the vertexes between which the distance is smaller than a vertex combining threshold are combined into one vertex (i.e., position-adjacent vertexes are deleted from the vertex array list until only one vertex among these position-adjacent vertexes is left). In embodiments of the present disclosure, the vertex combining threshold may be preset in the system. The connected vertexes include any two vertexes constituting a same triangle face. The distance between vertexes may be computed using the Pythagorean theorem, i.e., distance=\sqrt{x2+y2+z2}. In embodiments of the present disclosure, the connected vertexes refer to adjacent vertexes.

Alternatively, unnecessary vertex data (such as the normal vector, the UV and the like; the actually required data depend on a visual effect to be presented) may be deleted from the vertex array list. For example, when making a pure white statistic theme, since there is no color and a vertex animation is not needed, the normal vector, the vertex color and the UV may be deleted. In contrast, when making an earth model, since the earth is colorful, and a water wave animation is needed for the ocean region, the normal vector (the water wave may move in a direction of the normal vector) and the vertex color should be kept and the UV may be deleted.

At block S702, the terminal device adds a vertex color to the vertex data.

Alternatively, after acquiring the vertex data and before adding the vertex color to the vertex data, the method also includes: determining UV coordinates of corresponding to three-dimension coordinates of the vertex data in a UV mapping according to the three-dimension coordinates of the vertex data; and determining a pixel color corresponding to the UV coordinates as the vertex color.

The color of a pixel on the corresponding UV position on the model mapping is read from the vertex array list according to the vertex UV and wrote into the vertex color data in the vertex data. The vertex data consist of several customized arrays, when adding the color data, an array consisting of color float value (such as red with RGB [1.0, 0.0, 0.0] or semitransparent blue with RGBA [0.0, 0.0, 1.0, 0.5]) of each vertex is created.

At block S703, the terminal device generates the live wallpaper according to the vertex data with the added vertex color.

Alternatively, the terminal device may render the vertex data according to the vertex color in a GL_POINT rendering manner, so as to generate the live wallpaper. Furthermore, the terminal device may also render the vertex data according to the vertex color by using other tools to generate the live wallpaper. In embodiments of the present disclosure, GL_POINT is a rendering approach (rendering points) in OpenGL. Moreover, there are other rendering manners including GL_TRIANGLE (rendering faces), GL_LINE (rendering lines) and the like. OpenGL is a rendering API, most mobile phones use OpenGL ES to perform the rendering (except for the Windows Phone, which uses Direct3D).

After the terminal device generates the live wallpaper, the live wallpaper may be played. For example, a boat is floating along a river, a sea level is fluctuating and forming waves and the like.

Alternatively, after the terminal device plays the live wallpaper, an operation inputted by a user for the live wallpaper may be monitored. The operation includes but not be limited to: clicking, long-pressing, sliding on the screen, dragging, tilting the phone (gravity induction) and the like. If the terminal device detects the operation inputted by the user, a displaying of the live wallpaper is adjusted dynamically. In other words, the wallpaper may give a feedback corresponding to the motion. If the terminal device does not detect the operation inputted by the user, the live wallpaper may remain being played.

For example, the live wallpaper is a 3D map of New York city consisting of light spots, and there is a boat consisting of the light spots is sailing on a river in the wallpaper. When the user takes up the phone and tilts the phone in different directions, the live wallpaper may rotate to the corresponding direction due to the gravity induction. When the user slides on the screen, the vertexes on live wallpaper may rotate to the sliding direction. When the use long-presses a certain icon (such as the boat on the river) in the live wallpaper, the boat on the river may be zoomed in and displayed. When the user drags the boat, the boat may rotate left and right to the dragging direction. When the user finishes the dragging, the boat is zoomed out as the original size.

Compared to a common 3D live wallpaper, it is easier to meet some special visual needs (such as a high-tech holographic projection effect, a water splash scene, etc.) by implementing the present disclosure. As the rendering is performed on the vertexes which are regarded as separate points, even the drastically distorted vertex animation is played, the crumpling situation due to the points cannot forming a triangle may not appear in the model. Problems such as overheating, electricity consumption and halting of the mobile phone due to the usage of the 3D live wallpaper may be solved. Furthermore, with respect to point cloud data (generally generated by a 3D scanner), the point cloud data may be rendered directly to the live wallpaper in a point-rendering manner.

The method of embodiments of the present disclosure is described in detail above. In order to facilitate implementations of the above solutions of embodiments of the present disclosure, accordingly, a related apparatus configured to implement the above solutions is provided in following.

Referring to FIG. 8, FIG. 8 is a structure diagram illustrating an apparatus for generating a live wallpaper provided by an embodiment of the present disclosure. As shown in FIG. 8, the apparatus 80 for generating a live wallpaper includes: an acquiring unit 801, an adding unit 802 and a generating unit 803.

The acquiring unit 801 is configured to acquire vertex data extracted from a three-dimension model or point cloud data.

The adding unit 802 is configured to add a vertex color to the vertex data.

The generating unit 803 is configured to generate the live wallpaper according to the vertex data with the added vertex color.

Alternatively, the apparatus 80 also includes a combining unit 804, configured to combine the vertex data of two adjacent vertexes between which a distance is smaller than or equal to a preset vertex combining threshold into one piece of vertex data before the adding unit 802 adds the vertex color to the vertex data.

Alternatively, the apparatus 80 also includes a first determining unit 805 and a second determining unit 806.

The first determining unit 805 is configured to determine UV coordinates corresponding to three-dimension coordinates of the vertex data in a UV mapping according to the three-dimension coordinates of the vertex data before the adding unit 802 adds the vertex color to the vertex data.

The second determining unit 806 is configured to determine a pixel color corresponding to the UV coordinates as the vertex color.

Alternatively, the generating unit is 803 is configured to render the vertex data according to the vertex color in a GL_POINT rendering manner to generate the live wallpaper.

Alternatively, the apparatus 80 also includes a playing unit 807, a receiving unit 808 and an adjusting unit 809.

The playing unit 807 is configured to play the live wallpaper after the generating unit 803 generates the live wallpaper according to the vertex data and the vertex color.

The receiving unit 808 is configured to receive an operation inputted for the live wallpaper.

The adjusting unit 809 is configured to adjust a displaying of the live wallpaper dynamically according to the operation.

It may be understood that, functions of the respective functional units of the apparatus 80 for generating the live wallpaper of this embodiment may be realized according to the method embodiment in FIG. 7 described above, which will not be described in detail herein.

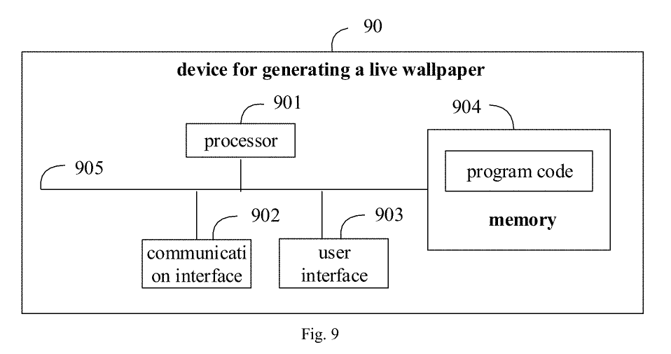

Referring to FIG. 9, FIG. 9 is a structure diagram illustrating a device for generating a live wallpaper provided by an embodiment of the present disclosure. The device 900 for generating the live wallpaper described in this embodiment includes: at least one processor 901, a communication interface 902, a user interface 903 and a memory 904. The processor 901, the communication interface 902, the user interface 903 and the memory 904 are connected via a bus or in other manners. Embodiments of the present disclosure take connecting via the bus as an example.

The processor 901 may be a general processor, for example, a central processing unit (CPU).

The communication interface 902 may be a wired interface (such as an Ethernet interface) or a wireless interface (such as a cellular network interface or using a wireless LAN interface), being configured to communicate with other devices or servers.

The user interface 903 may be a touch panel, including a touch screen and a touch control screen, and being configured to detect operating instructions on a touch panel. The user interface 903 may also be a physical button or a mouse. The user interface 903 may also be a display screen configured to output and display images or data.

The memory 904 may include a volatile memory, such as random access memory (RAM). The memory may also include a non-volatile memory, such as a read-only memory (ROM), a flash memory, a hard disk drive (HDD) or a solid-state drive (SSD). The memory 904 may also include a combination of above-mentioned memories. The memory 904 is configured to store program codes for generating live wallpaper. The processor 901 is configured to call the program codes stored on the memory 904 to execute: acquiring vertex data extracted from a three-dimension model or point cloud data; adding a vertex color to the vertex data; and generating the live wallpaper according to the vertex data with the added vertex color.

Alternatively, before the processor 901 adds the vertex color to the vertex data, the processor 901 is also configured to: combine the vertex data of two adjacent vertexes between which a distance is smaller than or equal to a preset vertex combining threshold into one piece of vertex data.

Alternatively, before the processor 901 adds the vertex color to the vertex data, the processor 901 is also configured to: determine UV coordinates corresponding to three-dimension coordinates of the vertex data in a UV mapping according to the three-dimension coordinates of the vertex data; and to determine a pixel color corresponding to the UV coordinates as the vertex color.

Alternatively, the processor 901 generates the live wallpaper according to the vertex data with the added vertex color by performing an act of: rendering the vertex data according to the vertex color in a GL_POINT rendering manner to generate the live wallpaper.

Alternatively, after the processor 901 generates the live wallpaper according to the vertex data and the vertex color, the processor is also configured to: play the live wallpaper; receive an operation inputted for the live wallpaper; and to adjust a displaying of the live wallpaper dynamically according to the operation.

It may be understood that, acts performed by the processor 901 may refer to the content described in embodiment of FIG. 7, which will not be described in detail herein.

Based on a same inventive concept, embodiments of the present disclosure also provide a storage medium configured to store application programs. When the application programs are running on a computer, the computer is configured to perform the method for generating a live wallpaper as shown in FIG. 7.

Based on a same inventive concept, embodiments of the present disclosure also provide an application program. When the application program is running on a computer, the computer is configured to perform the method for generating a live wallpaper as shown in FIG. 7.

In conclusion, by implementing embodiments of the present disclosure, it is easy to meet some special visual needs (such as a high-tech holographic projection effect, a water splash scene, etc.) by implementing the present disclosure. As the rendering is performed on the vertexes which are regarded as separate points, even the drastically distorted vertex animation is played, the crumpling situation due to the points cannot forming a triangle may not appear in the model. Problems such as overheating, electricity consumption and halting of the mobile phone due to the usage of the 3D live wallpaper may be solved. Furthermore, with respect to point cloud data (generally generated by a 3D scanner), the point cloud data may be rendered directly to the live wallpaper in a point-rendering manner.

The skilled in the art may understand that, all or a part of the process in the method according to the above-mentioned embodiments may be realized by computer programs instructing related hardware. The program may be stored on a computer readable storage medium, when the program is executed, the program may include processes of the above-mentioned method embodiments. The storage medium may be a fluffy disk, an optical disk, ROM or RAM and the like.

Steps in the method of embodiments of the present disclosure may be reordered, combined and deleted according to practical requirements.

Units in the apparatus for generating a live wallpaper may be combined, divided and deleted according to practical requirements.

The above embodiments are merely to describe technical solutions of the present disclosure, but not to limit the present disclosure. The skilled in the art may understand all or a part of process of the above-mentioned embodiments. Changes and alternatives made by those skilled in the art according to the claims of the present disclosure should be covered in a protective scope of the present disclosure.

What is claimed is:

1. A method for generating a live wallpaper, comprising:
acquiring vertex data extracted from at least one of a three-dimension model and point cloud data;
adding a vertex color to the vertex data; and
generating the live wallpaper according to the vertex data with the added vertex color.

2. The method according to claim 1, wherein before adding the vertex color to the vertex data, the method further comprises:
combining the vertex data of two adjacent vertexes between which a distance is smaller than or equal to a preset vertex combining threshold into one piece of vertex data.

3. The method according to claim 1, wherein before adding the vertex color to the vertex data, the method further comprises:
determining UV coordinates corresponding to three-dimension coordinates of the vertex data in a UV mapping according to the three-dimension coordinates of the vertex data; and
determining a pixel color corresponding to the UV coordinates as the vertex color.

4. The method according to claim 1, wherein generating the live wallpaper according to the vertex data with the added vertex color comprises:
rendering the vertex data according to the vertex color in a GL_POINT rendering manner to generate the live wallpaper.

5. The method according to claim 1, wherein after generating the live wallpaper according to the vertex data with the added vertex color, the method comprises:
playing the live wallpaper;
receiving an operation inputted for the live wallpaper; and
adjusting a displaying of the live wallpaper dynamically according to the operation.

6. The method according to claim 2, wherein after generating the live wallpaper according to the vertex data with the added vertex color, the method comprises:
playing the live wallpaper;
receiving an operation inputted for the live wallpaper; and
adjusting a displaying of the live wallpaper dynamically according to the operation.

7. The method according to claim 3, wherein after generating the live wallpaper according to the vertex data with the added vertex color, the method comprises:
playing the live wallpaper;
receiving an operation inputted for the live wallpaper; and
adjusting a displaying of the live wallpaper dynamically according to the operation.

8. The method according to claim 4, wherein after generating the live wallpaper according to the vertex data with the added vertex color, the method comprises:
playing the live wallpaper;
receiving an operation inputted for the live wallpaper; and
adjusting a displaying of the live wallpaper dynamically according to the operation.

9. An apparatus for generating a live wallpaper, comprising: a processor, a memory, a communication interface and a bus, wherein the processor, the memory and the communication interface are connected via the bus and communicate with each other; the memory is configured to store executable program codes; and the processor is configured to:
acquire vertex data extracted from at least one of a three-dimension model and point cloud data;
add a vertex color to the vertex data; and
generate the live wallpaper according to the vertex data with the added vertex color.

10. The apparatus according to claim 9, wherein the processor is configured to:
combine the vertex data of two adjacent vertexes between which a distance is smaller than or equal to a preset vertex combining threshold into one piece of vertex data before the adding unit adds the vertex color to the vertex data.

11. The apparatus according to claim 9, wherein the processor is configured to:
determine UV coordinates corresponding to three-dimension coordinates of the vertex data in a UV mapping according to the three-dimension coordinates of the vertex data before the adding unit adds the vertex color to the vertex data; and
determine a pixel color corresponding to the UV coordinates as the vertex color.

12. The apparatus according to claim 9, wherein the processor generates the live wallpaper according to the vertex data with the added vertex color by acts of:
rendering the vertex data according to the vertex color in a GL_POINT rendering manner to generate the live wallpaper.

13. The apparatus according to claim 9, wherein the processor is configured to:
play the live wallpaper after the generating unit generates the live wallpaper according to the vertex data with the added vertex color;
receive an operation inputted for the live wallpaper; and
adjust a displaying of the live wallpaper dynamically according to the operation.

14. The apparatus according to claim 10, wherein the processor is configured to:
play the live wallpaper after the generating unit generates the live wallpaper according to the vertex data with the added vertex color;
receive an operation inputted for the live wallpaper; and
adjust a displaying of the live wallpaper dynamically according to the operation.

15. The apparatus according to claim 11, wherein the processor is configured to:
play the live wallpaper after the generating unit generates the live wallpaper according to the vertex data with the added vertex color;
receive an operation inputted for the live wallpaper; and
adjust a displaying of the live wallpaper dynamically according to the operation.

16. The apparatus according to claim 12, wherein the processor is configured to:
play the live wallpaper after the generating unit generates the live wallpaper according to the vertex data with the added vertex color;
receive an operation inputted for the live wallpaper; and
adjust a displaying of the live wallpaper dynamically according to the operation.

17. A non-transitory computer storage medium, having computer programs stored therein, wherein the computer programs comprise program instructions, when the program instructions are executed by a processor, a method for generating a live wallpaper is performed, the method comprises:
acquiring vertex data extracted from at least one of a three-dimension model and point cloud data;
adding a vertex color to the vertex data; and
generating the live wallpaper according to the vertex data with the added vertex color.
